(19) United States
(12) Patent Application Publication
(10) Pub. No.: US 2010/0006668 A1
(43) Pub. Date: Jan. 14, 2010

(54) PRESSURE WASHER WITH HEAT TRANSFER UNIT FOR HOT WATER DISCHARGE

(75) Inventors: Gus Alexander, Inverness, IL (US); Billy Eugene Turner, Siloam Springs, AR (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: FAIP North America, Inc., Elk Grove Village, IL (US)

(21) Appl. No.: 12/441,482

(22) PCT Filed: Sep. 18, 2007
(86) PCT No.: PCT/US07/20187

§ 371 Date: Mar. 16, 2009

Related U.S. Application Data
(60) Provisional application No. 60/845,414, filed on Sep. 18, 2006.

(51) Int. Cl. B05B 9/04; B05B 7/16

(52) U.S. Cl. 239/129

(57) ABSTRACT

A pressure washer is provided. The pressure washer includes a water inlet port for receiving water from a water source. A water outlet port is in fluid communication with the water inlet port. A pump is in fluid communication with the water inlet port and the water outlet port for pressurizing the water received through the water inlet port and pumping the pressurized water through the water outlet port. An internal combustion engine powers the pump. A heat transfer unit is interposed between and in fluid communication with the water inlet port and the water outlet port. The heat transfer unit receives exhaust gas from the internal combustion engine and uses the exhaust gas to heat the water as it travels between the water inlet port and the water outlet port.

### FIELD OF THE INVENTION

The present invention relates generally to pressure washers, and more particularly, to gasoline-powered pressure washers commonly used for household power spraying and washing applications.

### BACKGROUND OF THE INVENTION

Gasoline-powered pressure washers have become increasingly popular for use in household cleaning applications, including cleaning decks, patios, siding, automobiles, and the like. Such pressure washers now are economically manufactured and available to the consumer in most hardware and home improvement retail stores. Such gasoline-powered pressure washers basically comprise a movable cart or stand, a water pump, an internal combustion engine for powering the pump, and a spray wand and nozzle assembly. Operation of the pressure washer, following coupling of a common garden hose between a home water outlet and the inlet to the pressure washer pump, generates a high pressure liquid discharge up to 1000 psi and more, for power spraying applications. A chemical inlet port also can be provided on the pressure washer for enabling the introduction of cleaning chemicals into the liquid flow stream to enhance a cleaning operation.

While chemical intermixing and cleaning effectiveness can be greatly enhanced by use of hot water, inexpensive consumer type pressure washers typically only are available for cold water use operation, such as when connected to a household water outlet. While commercial grade pressure washers are available for directing hot water, these systems require that the pressurized liquid be directed through a downstream heat exchanger separately powered from a fuel other than gasoline, such as propane gas, natural gas or electricity. Such systems are prohibitively expensive for the consumer market. Relatively inexpensive gasoline-powered pressure washers sold in the household or consumer market also can suffer from environmental problems, including excessive noise and inefficient fuel consumption and emissions.

### OBJECTS AND BRIEF SUMMARY OF THE INVENTION

It is an object of the present invention to provide an economical gasoline-powered pressure washer for the consumer market which is adapted for improved cleaning efficiency.

Another object is to provide a gasoline-powered pressure washer as characterized above which is operable for directing a hot water discharge for intermixing with cleaning chemicals and more effective cleaning.

A further object is to provide a gasoline-powered pressure washer of the above kind which permits heating of the liquid discharge without the necessity for an expensive heat exchanger that requires a separate fuel source.

Still another object is to provide a gasoline-powered pressure washer of the foregoing type that can be selectively operated for directing either a hot or a lower temperature pressurized liquid discharge.

Yet a further object is to provide a gasoline-powered pressure washer of such type in which the hot liquid discharge is directed in a high frequency pulsating stream for enhanced cleaning. A related object such as a gasoline-powered pressure washer in which the hot liquid discharge pulsates up to 1000 impulses per minute.

Another object is to provide a gasoline-powered pressure washer of the above kind that can be operated with reduced noise and fuel emissions.

Yet a further object is to provide a heat exchanger that can be economically retrofit onto conventional consumer pressure washers for enabling the discharge of high pressure hot water.

Other objects and advantages of the invention will become apparent upon reading the following detailed description and upon reference to the drawings, in which:

### BRIEF DESCRIPTION OF THE DRAWING(S)

FIG. 1 is a perspective of an illustrative pressure washer having a heat transfer unit in accordance with the invention;

FIG. 2 is a further perspective of the pressure washer shown in FIG. 1;

FIG. 3 is an enlarged longitudinal section of the heat transfer unit of the illustrated pressure washer;

FIG. 4 is a diagrammatic depiction of the piston pump of the illustrated pressure washer;

FIG. 4A is a diagrammatic depiction of the piston pump of the pressure washer with a selectively lockable valve for disabling operation of one of the pistons;

FIG. 5 is a flow diagram of the illustrated pressure washer having a piston pump as shown in FIG. 4;

FIG. 6 is a diagrammatic depiction of an alternative piston pump control that can be used with the illustrated pressure washer;

FIG. 7 is a flow diagram of the operation of a flow diagram of the pressure washer having the piston pump shown in FIG. 6; and

FIG. 8 is an enlarged longitudinal section of an alternative embodiment of heat transfer unit usable with the illustrated pressure washer.

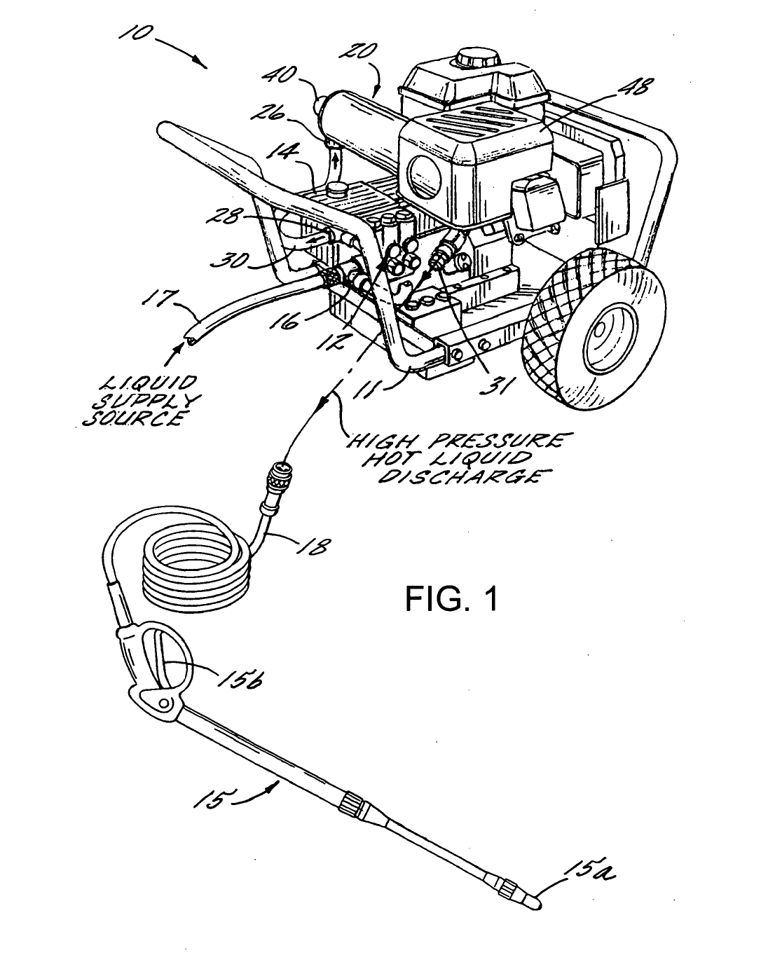

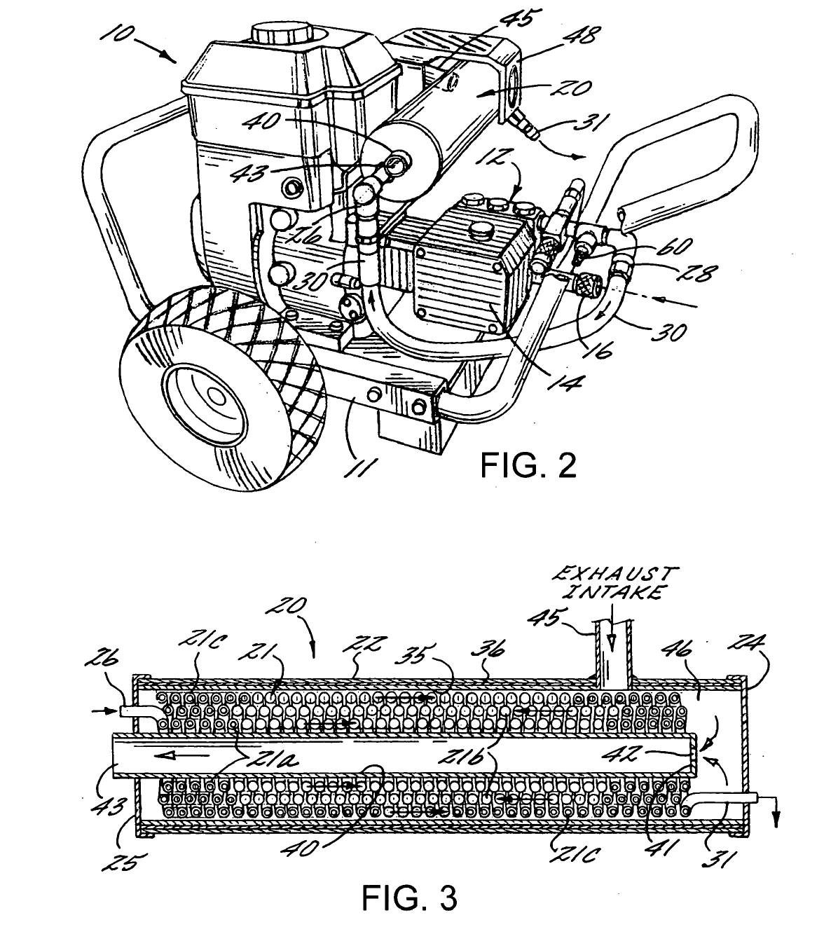

While the invention is susceptible of various modifications and alternative constructions, certain illustrative embodiments thereof have been shown in the drawings and will be described below in detail. It should be understood, however, that there is no intention to limit the invention to the specific form disclosed, but on the contrary, the intention is to cover all modifications, alternative constructions, and equivalents falling within the spirit and scope of the invention.

### DETAILED DESCRIPTION OF PREFERRED EMBODIMENTS

Referring now more particularly to the drawings, there is shown an illustrative pressure washer 10 in accordance with the invention which basically includes a wheeled frame 11 that carries a liquid pump 12, a gasoline powered internal combustion engine 14 for operating the pump 12, and a operator wand or spray gun 15 connected to the pressure washer via a high pressure fluid transfer hose 18. The pump 12 has an inlet 16 connectable to a liquid supply source, such as a home water outlet, by a garden hose 17 or the like. The operator wand 15 typically includes a nozzle 15a and a trigger valve 15b of a known type for allowing the operator to controllably direct a stream of pressurized liquid toward a substrate surface for cleaning. The high pressure hose 18 preferably has a reinforced construction, such a disclosed in U.S. Pat. No. 5,964,409, the disclosure of which is incorporated herein by reference. The hose 18 and wand 15 each may be provided with conventional fittings and couplings to effect appropriate fluid type connections therebetween.

In accordance with the invention, the gasoline-powered pressure washer has a heat transfer unit that is operable without a separate fuel source for efficiently and economically heating water for more effective cleaning. To this end, the illustrated pressure washer 10 has a heat transfer unit 20 interposed between the liquid pump 12 and the high pressure outlet hose 18 which utilizes exhaust gas of the gasoline powered engine 14 for heating the liquid exiting from the pump 12 prior to direction to and discharge from the spray wand 15. The heat transfer unit 20 in this case comprises a liquid heat transfer coil 21 preferably formed by a continuous, seamless stainless steel tube contained within an outer cylindrical casing 22 having end caps 24, at opposite axial ends. The heat transfer coil 21 in this instance has an inlet end 26 connected to a liquid outlet 28 of the pump 12 via a high pressure hose 30 and a liquid discharge end 31 coupled to the high pressure hose 18 communicating with the spray wand 15. The coil 21 preferably defines a plurality of concentric layers or rows of windings of the continuous wound tubing. The illustrated coil 21 comprises three concentric layers or rows of 21a, 21b, 21c of windings. The liquid inlet 26 in this case communicates with an inner layer or row 21a of windings, which in turn communicates at a downstream end with a second layer 21b of windings, which in turn communicates with an outer or third row layer 21c of windings, which in turn communicates with the discharge end outlet 31 of the coil. It will be seen that liquid directed through the heat transfer coil 21 will travel in serpentine fashion, first being directed from the inlet 26 through the inner row 21a of coil windings from left to right as viewed in FIG. 3, then through the second row 21b of coil windings in an opposite right to left direction, and then through the outer row or layer 21c of coil windings again in an opposite direction left to right to the coil outlet 31. The coil 21 preferably may be formed of 3/16″ or ⅛″ stainless steel seamless tubing, and preferably, the individual rounds are spaced apart slightly to provide air flow therebetween, as will become apparent. The coil 21 in this case is disposed within an inner tubular jacket 35, also preferably made of stainless steel, which in turn is disposed within the outer tubular jacket 22 with a layer of insulation 36 there between. The insulation preferably is a ceramic fiber type.

In carrying out the invention, the heat transfer unit 20 is directly coupled to the exhaust port of the internal combustion engine 14 for receiving exhaust gases during operation of the pressure washer and includes an exhaust gas flow distributor tube 40 centrally within the heat transfer coil 21 for facilitating the flow of the exhaust gases through the heat transfer coil 21 for efficient heat transfer to liquid passing through the coil 21 prior to direction of the pressurized liquid to the outlet hose 18 and control wand 15. The gas flow distributor tube 40 in this case preferably has an uninterrupted tubular side wall concentrically disposed within the heat transfer coil 21 with an end plate 41 at an upstream end formed with a central gas flow passageway 42. The gas flow distributor tube 40 has an open discharge end 43 that is fixed in sealed relation within the downstream end plate 25 of the heat transfer unit 20.

Exhaust gases from the internal combustion engine 14 in this case are transferred via a rigid manifold pipe 45, preferably made of metal, which communicated through a side of the heat transfer unit 20 near an upstream end into an axial space 46 between the heat transfer end plate 24 and the upstream ends of the heat transfer coil 21 and exhaust gas flow distributor tube 40. Hot exhaust gases discharging from the engine during operation of the pressure washer thereby are directly introduced into the heat transfer unit 20 for circulation about the layers 21a, 21b, 21c of windings of the heat transfer coil 21 along its length. The exhaust gas ultimately will flow through the central gas passageway 42 in the upstream end of the exhaust gas flow distributor tube 40 for ultimate discharge to the atmosphere from the open downstream discharge end 43 thereof. It will be understood that the arrangement of the inner and outer tubular casings 35, 22 with the interposed insulation 36 not only maintains heat within the heat transfer unit 20 for more efficient heating of liquid passing through the heat transfer coil 21, but also prevents dangerous overheating of the exterior surface of the outer tubular casing 22. In the illustrated embodiment, a shroud 48 also is provided over the heat transfer unit 20 for enhanced aesthetic appearance as well as for preventing inadvertent manual contact with the heat transfer unit. It further has been unexpectedly found that the heat transfer unit 20 effectively muffles sound from the engine such that the pressure washer can be operated at reduced noise levels without the necessity for further muffling. Transmission of the hot exhaust gases through the heat transfer unit further is believed to enhance efficient fuel utilization while facilitating complete combustion with reduced exhaust gas admissions.

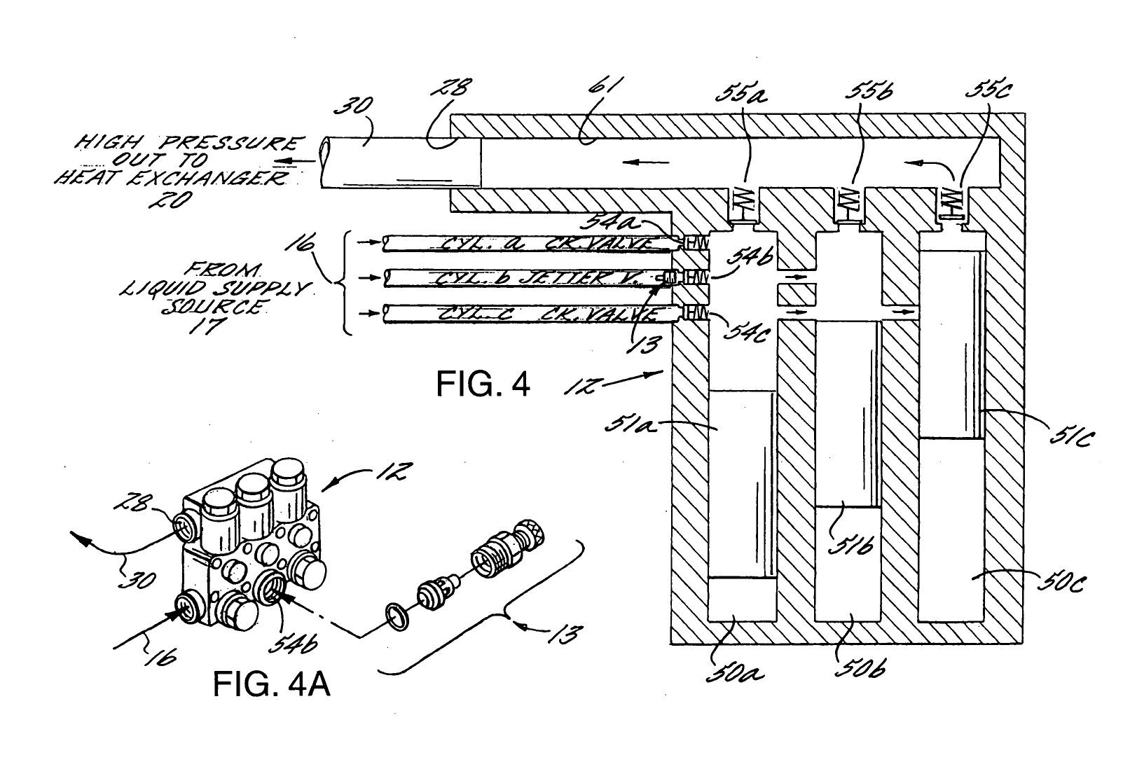

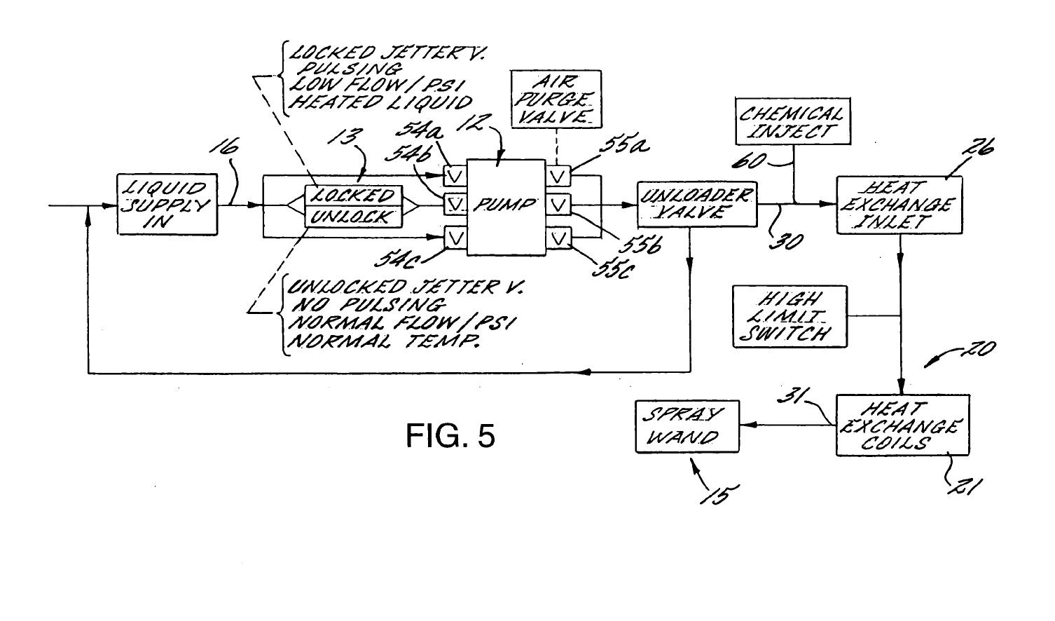

In accordance with a further aspect of the invention, the pressure washer 10 is selectively operable in a pulsating, hot water pressurized liquid dispensing mode or in a higher volume, lower temperature liquid dispensing mode. To this end, the illustrated pump 12 (FIG. 4) is a piston pump having three cylinders 50a, 50b, 50c each having a respective piston 51a, 51b, 51c operated by a respective crank from a common crank shaft driven from the gas powered motor 20 in a conventional manner. During each operating cycle, reciprocating movement of the pistons 51a, 51c sequentially opens an inlet valve 54 to the cylinder chamber to draw in a predetermined quantity of liquid, while a respective outlet valve 55a, 55b, 55c is closed, and reverse movement closes the inlet valve while directing liquid under pressure into a manifold chamber 61 of the pump. The sequential operation of the pistons creates a uniform, high volume, high pressure, liquid flow from the pump.

In carrying out the invention, at least one of the piston chamber inlet valves can be selectively locked in a closed position for reducing the liquid flow rate through the pump to facilitate heating of the liquid to a relatively higher temperature. In addition, the resulting asymmetrical action of the remaining pistons driving liquid through the pump causes a pulsating discharge to occur, up to 1000 pulses per minute. In the illustrated embodiment shown in FIG. 4, the inlet valve 54b to the second or middle piston 51b of the pump 21 is a disabling valve 13, which can be selectively locked into a closed position, thus making the piston inoperable. The remaining two pistons 51a, 51c remain operational, causing the pump to “pulse” by throwing the system into an imbalanced configuration. It also causes the flow volume to lower, thus allowing the waters to spend more time in the heat transfer unit 20 for heating to a higher temperature. The valve 13, which may be of a known type commercially available under the name Jetter, can be rotatably adjusted in the pump housing for preventing opening of the valve during an intake stroke. Selective rotation of the valve in an opposite direction releases the locking action permitting the piston to operate in its normal fashion.

It will be understood by one skilled in the art that the combination of the higher water temperature and forcible pulsation of the discharging stream will enhance effective cleaning action of the discharging stream notwithstanding its lower flow rate. In practice, it has been found that the pressure washer can be operated in the high temperature mode at a rate of 1 to 1.5 gpm at a pressure of 1,000 psi. These parameters result in an outlet liquid temperature of between 130° and 140° F.

To further enhance cleaning, the pressure washer has a chemical injection port 60 which enables cleaning chemicals to be added into the flow stream prior to direction to the heat transfer unit 20, such as by a conventional siphon intake. Subsequent heating of the water chemical solution and the pulsating direction of the liquid onto a substrate surface further effectively enhances cleaning.

In keeping with the invention, the pressure washer may be selectively operated at a higher volume, lower water temperature operation by simply unlocking the jitter valve 54b. In that case, each of the three pistons 51a-51c is operational in directing water from the supply source. It will be understood that the higher volume flow will result in a lower temperature elevation as it is directed to the heat transfer unit. Nevertheless, the higher volume, lower temperature discharge may be preferred, such as during rinsing operations, and the operating mode of the pressure washer is easily changed by selective adjustment of the jitter valve 54b.

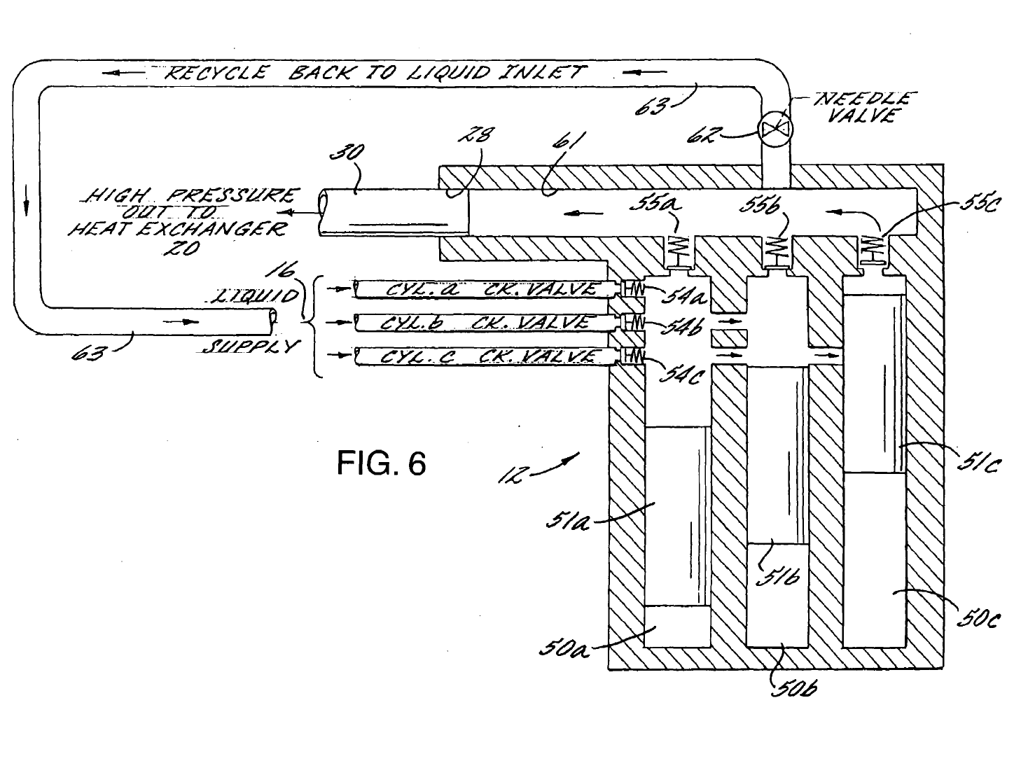

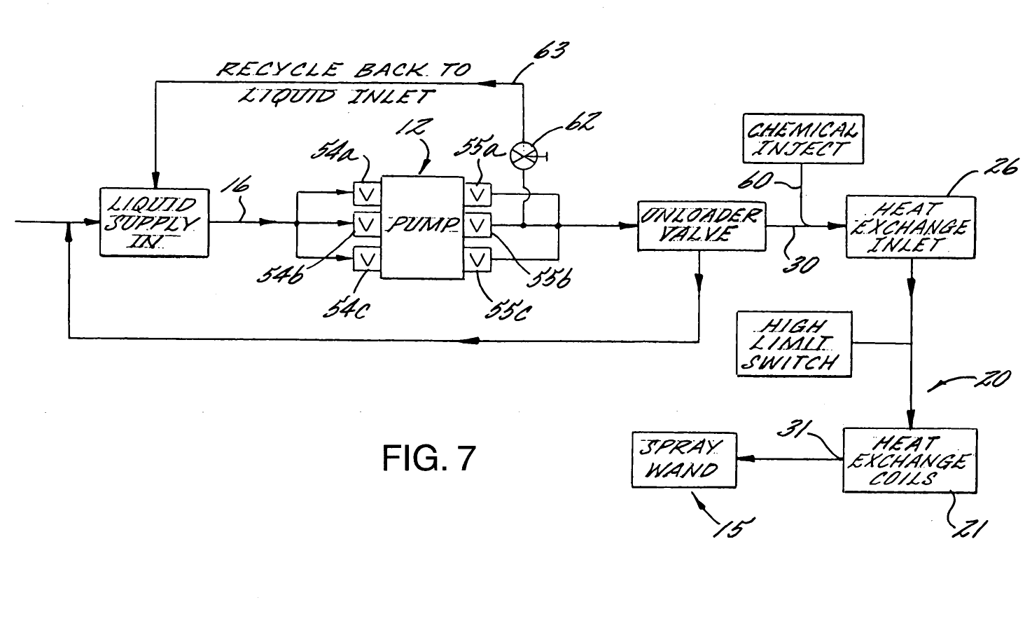

An alternative embodiment of control for selectively operating that pressure washer in a relatively high temperature pulsating flow stream and a relatively lower temperature high volume flow stream is depicted in FIGS. 6 and 7. In this case, each of the inlet valves 54a-54c are conventional, spring operated and a bypass passageway line 63 is provided between the outlet manifold passage 61 of the pump 20 and the liquid inlet of the pump 20. The bypass line 63 in this case communicates in diametrically opposed relation to the outlet valve 55b of the piston 51b such that a significant portion of the discharge from that piston will be directed into the bypass line 63. Through operation of a needle valve 62, the bypass line 63 may be opened to permit a portion of the liquid to be drawn from the liquid passage manifold 61 and recirculated through the system. It will be understood, like in the previously described embodiment, the effective discharge rate of liquid from the pressure washer is reduced resulting in heating of the remaining liquid to a higher temperature during its passage through the heat transfer unit. By reason of the imbalanced state of the pumping system, the discharging flow again has a pulsating effect to at least some degree for enhanced cleaning. Selectively adjusting the needle valve to a bypass passage closed position again enables the pump to operate at a higher volume lower temperature operating mode for rinsing or other cleaning applications.

In carrying out still a further aspect of the invention, the heat transfer unit 20 can be used in retrofitting existing pressure washers. In such case, the heat transfer unit would be appropriately mounted on the pressure washer, a manifold pipe for connecting the exhaust port of the internal combustion engine to the inlet port of the heat transfer unit and the liquid outlet of the heat transfer unit would be connected to the high pressure hose of the control wand. It will be appreciated that the heat transfer unit can be mounted on most existing internal combustion engine powered pressure washers in such manner with little or minimal modifications. The relatively simple mounting procedure can be carried out by a user of the pressure washer with common tools and limited technical knowledge of the pressure washer, allowing a cold water pressure washer unit to be easily converted to an economical high water unit through such retrofitting of a fixed heat transfer unit.

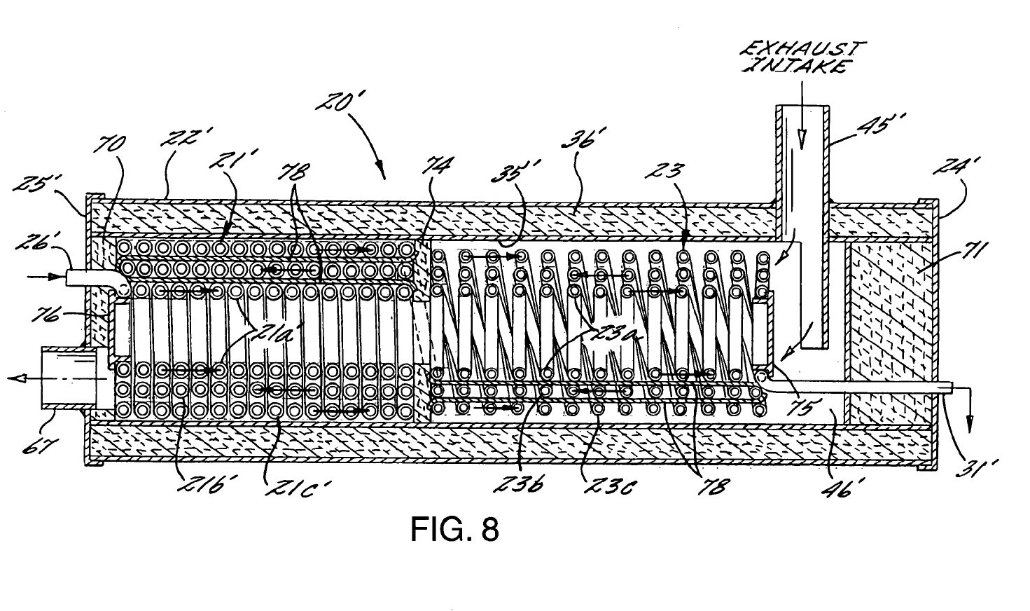

Referring now to FIG. 8 of the drawings, there is shown an alternative and preferred embodiment of a heat transfer unit 20′ usable in the pressure washer 10 in accordance with the invention, wherein items similar to those described above have been given similar reference numerals with the distinguishing suffix “′”. The heat transfer unit 20′ again has a housing defined by an outer cylindrical casing 22′ and end plates 24′, 25′ at opposite axial ends thereof. The heat transfer unit 20′ in this case utilizes a dual coil longitudinally-spaced liquid heat transfer tubing without a central exhaust gas flow distributor tube. To this end, the heat transfer unit 20′ includes a first upstream heat transfer coil 21′ formed of relatively large diameter tubing, such as ¼″ tubing, having an inlet 26′ communicating with the cold water liquid supply, in this case from the outlet of the pressure washer pump. The coil 21′ is defined by three concentrically wound continuous layers or rows 21a′, 21b′, 21c′ of windings, similar to that described above, with the liquid inlet 26′ communicating with the inner layer 21a′ of windings, which in turn communicates at a downstream end with a second or intermediate layer 21b′ of windings, which in turn communicates with an outer or third layer 21c′ of windings.

In keeping with the invention, the first heat transfer coil 21′ communicates with a downstream longitudinally adjacent second coil 23 formed of relatively smaller diameter tubing, such as 3/16″ diameter tubing. The downstream smaller diameter tubing coil 23 again has three concentric layers or rows 23a, 23b, 23c of windings with an upstream end of the outer layer 23c communicating with the downstream end of the outer layer 21c of the first coil 21, which in turn communicates at a downstream end with the intermediate or second layer 23b of windings, which in turn communicates with an upstream end with the inner layer 23a of windings, which in turn communicates with the liquid discharge end outlet 31′ of the heat transfer unit 20′ coupled to the high pressure hose of the spray control wand or gun. It will be seen that liquid directed through the heat transfer unit will travel in two distinct serpentine paths, first being directed through the successive layers 21a′, 12b′, 21c′, from outer to inner layers of the first heat transfer coil 21 and then through successive layers 23c, 23b, 23a from the inner to the outer layers of the relatively smaller diameter downstream coil 23, prior to being transferred to the spray wand or gun.

In keeping with the invention, the exhaust manifold duct from the internal combustion engine of the pressure washer communicates through a cylindrical side of the heat transfer unit 20′ into an axial space 46′ between a downstream end of the smaller diameter heat transfer coil 23 and the axial end of the heat transfer unit. The heat transfer unit 20′ in this case has an exhaust outlet tube 67 mounted in off-centered relation to the end plate 25′ in diametrically opposed relation to the liquid inlet 26′.

For enhancing heat transfer efficiency, the heat transfer unit 20′ in this instance has relatively thick insulation layers, which include an outer cylindrical insulation layer 36′ having a thickness of at least ⅕^{th} the radius of the heat transfer unit interposed between the outer casing 22′ and an inner cylindrical casing 35′ of the heat transfer unit, an axial heat transfer layer 70 adjacent the end plate 25′, a relatively thick end insulating layer 71 adjacent the end plate 24′ and the exhaust manifold inlet 45′, and an intermediate insulating layer 74 between the longitudinally spaced upstream and downstream liquid heat transfer coils 21′, 23. The intermediate insulating layer 74 is annular shaped with an internal opening corresponding with the diameter of the inner layers of the heat transfer coils 21′, 23.

In further carrying out this aspect of the invention, to facilitate circulation of exhaust gas through the heat transfer unit 20′ for enhanced heat transfer to liquid passing through the longitudinally aligned coils 21′, 23, end caps 75, 76 are respectively mounted in opposite ends of the heat transfer coils 21′, 23 for preventing the direct axial flow of exhaust gas through the coils 21′, 23 and a plurality of circumferentially spaced longitudinal extending spaced gas distribution strips 78 are interposed between the layers of the coils for facilitating circulation of gas through the coils for efficient heat transfer.

It has been found that during operation of the pressure washer with the heat transfer unit 20′, exhaust gas is forced to circulate throughout the heat transfer coils 21′, 23 with hotter gases effecting heat transfer between the smaller diameter tubing of the heat transfer coil 23 and the larger surface area of the larger diameter tubing of the coil 21′ effecting enhanced heat transfer even while the temperature is being lowered prior to discharge through the exhaust outlet tube. The heat transfer unit 20′ again is of relatively simple construction and lends itself to economical manufacture, efficient use, and easy retrofitting on existing pressure washers.

From the foregoing, it can be seen that an economical gasoline powered pressure washer is provided that has particular utility in the consume market. It further enables improved cleaning efficiency through utilization of a pulsating high temperature liquid discharge which can be premixed with cleaning. The pressure washer permits heating of the liquid discharge without the necessity for expensive heat exchangers that require a separate fuel source. The pressure washer also can be selectively operated in either hot or a lower temperature liquid discharge modes. The pressure washer is economical in design and the heat transfer unit according to the invention lends itself to economical retrofitting on conventional pressure washers.

It will be understood that while in the illustrative embodiment a pump is disclosed which has a plurality of pistons driven by a crank shank disposed in perpendicular relation to piston movement, alternatively, an axial piston pump may be utilized in which pistons are driven by a wobble plate having a rotary access parallel to the piston movement. Moreover, while the illustrated gas flow distribution tube in the embodiment of FIG. 3 has an uninterrupted outer tubular construction, alternatively, axially-spaced air flow apertures may be provided in the perimeter of the tube to facilitate passage of gas through the heat transfer coil into the gas flow distributor tube along the length thereof.

1. A pressure washer comprising:
a water inlet port for receiving water from a water source;
a water outlet port in fluid communication with the water inlet port;
a pump in fluid communication with the water inlet port and the water outlet port for pressurizing the water received through the water inlet port and pumping the pressurized water through the water outlet port;
an internal combustion engine for powering the pump; and
a heat transfer unit interposed between and in fluid communication with the water inlet port and the water outlet port, the heat transfer unit receiving exhaust gas from the internal combustion engine and using the exhaust gas to heat the water as it travels between the water inlet port and the water outlet port.

2. The pressure washer according to claim 1 wherein the heat transfer unit is arranged downstream of the pump.

3. The pressure washer according to claim 1 wherein the heat transfer unit includes a heat transfer coil through which water is transmitted

4. The pressure washer according to claim 3 wherein the heat transfer coil includes a continuous wound tube arranged in a plurality of concentric layers.

5. The pressure washer according to claim 3 wherein the heat transfer unit further includes an exhaust gas flow distributor tube that extends through the heat transfer coil and is in communication with an exhaust port of the internal combustion engine.

6. The pressure washer according to claim 5 wherein the heat transfer coil and exhaust gas flow distributor tube are arranged in a casing that is in fluid communication with the exhaust port of the internal combustion engine and is configured such that exhaust gas received from the internal combustion engine circulates around the heat transfer coil and passes through the exhaust gas distributor tube.

7. The pressure washer according to claim 6 wherein the casing is insulated.

8. The pressure washer according to claim 1 wherein the pump includes a plurality of piston chambers at least one of which can be selectively closed so as to permit beating of the water to a relatively higher temperature and to produce a pulsating discharge of water through the water outlet port.

9. The pressure washer according to claim 1 further including a chemical injection port for introducing cleaning chemicals, the chemical injection port being arranged upstream of and in fluid communication with the heat transfer unit.

10. The pressure washer according to claim 1 wherein a bypass line is arranged at downstream end of the pump to circulate water back through the pump, the bypass being arranged opposite an outlet of a piston chamber of the pump.

11. The pressure washer according to claim 4 wherein the heat coil includes a first section and a second section, the wound tube having different diameters in the first and second sections.

12. The pressure washer according to claim 11 wherein the first section is arranged upstream of the second section and the wound tube has a relatively larger diameter in the first section.

13. The pressure washer according to claim 4 wherein an end cap is provided on each end of the heat transfer coil for preventing direct axial flow of exhaust gas through the coil.

14. The pressure washer according to claim 13 wherein a plurality of circumferentially spaced longitudinally extending gas distribution strips are interposed between at least some of the layers of the heat transfer coil.
